(19) United States
(12) Patent Application Publication
(10) Pub. No.: US 2003/0037153 A1
(43) Pub. Date: Feb. 20, 2003

(54) Information transfer protocol system and private exchange

(76) Inventor: Norman Ken Ouchi, San Jose, CA (US)

Correspondence Address: NORMAN KEN OUCHI, 20248 VIEW CREST CT, SAN JOSE, CA, 95120, US

(21) Appl. No.: 09/930,933

(22) Filed: Aug. 16, 2001

(51) Int. Cl. G06F 15/16

(52) U.S. Cl. 709/230

(57) ABSTRACT

The present invention is related to electronic information transfer between trading partners and more particularly to the information transfer protocols and processing, the topology of information exchange, and the delivery of the information transfer service. An information transfer protocol server provides a user interface for manual processing of information transactions. In addition, a filter function provides a means for integrating selected information transactions with other systems. A private exchange for exchanging information between trading partners where each trading partner has an information transfer protocol server and information is exchanged using the information transfer protocol.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

This invention is related to electronic information transfer between trading partners and more particularly to the information transfer protocols and processing, the topology of information exchange, and the delivery of the information transfer service.

### BRIEF SUMMARY OF THE INVENTION

In the present invention, an information transfer protocol server provides a user interface for manual processing of information transactions. In addition, a filter function provides a means for integrating selected information transactions with other systems. A private exchange for exchanging information between trading partners where each trading partner has an information transfer protocol server and information is exchanged using the information transfer protocol.

### BACKGROUND OF THE INVENTION

The present invention enables the electronic communications among trading partners to make commerce more effective. The electronic communications has two components: the protocol used for the communications and the topology used to enable the communications. A third factor is the means by which these capabilities are enabled or delivered.

### THE PROTOCOL

Successful enterprises are no longer large vertically organized companies like the Ford Motor Companies, Standard Oil's, and IBM's of old but agile organizations that have networks of trading partners, “supply chains”, that not only provide the components for their products but in many cases, design, manufacture, deliver, and service their products. Communication among these trading partners is critical and has given rise to a major business segment called electronic commerce where suppliers of software, networks, and services vie to provide these capabilities. Public standards have evolved to facilitate propagation of consistent communications among trading partners. Electronic Data Interchange, EDI, is one major standard and has been effective in the automotive industry. However, EDI has not been effective in the electronic technology industry or similar industries. Three companies dominated the automotive industry and could force the suppliers to conform to a standard. Of more importance was the stability of their forecasts; they could build what they had planned. The electronic commerce standard did not have to accommodate a highly volatile forecast to actual build relationship. The electronics technology industry could not build what they had planned but needed to build in response to the market. Because of the need to respond to the market, the orders had to change quickly and frequently. FIG. 1 illustrates the electronic commerce relationship between two trading partners. Partner A 1 uses enterprise systems A 2 to plan and execute its business. Partner B 4 uses their enterprise systems B 5 to run their business. Partner A 1 enterprise system A 2 uses EDI 6 to send a Purchase Order to order a quantity of an item at a specific price to be delivered on a specific date to partner B 4 enterprise system B 5 which uses EDI to send an acknowledge of the Purchase Order. However, EDI does not have the ability to easily communicate the messages needed to manage the changes to the Purchase Order, for example change the delivery date, during its life cycle so people 3, 10 must manage the business processes and communications for changes using FAX 7, e-mail 8, and phone 9. In the electronic technology industry, there may be five or six changes for each EDI Purchase Order before the order is actually delivered. As the need to keep inventory levels low and inventory turns high increases, the level of change increases. The people 3,10 driven processes usually do not have system assistance and are thus error prone. A number of electronics technology industry leaders recognized the need for a more complete electronics communications standard to not only solve the business issues of EDI but also take advantage of the omnipresence and capabilities of the Internet and World Wide Web. Their effort resulted in the creation of RosettaNet, a new public consortium to define and implement a new standard for business-to-business information transfer to solve the issues of the electronics technology industry using the Internet and Web.

RosettaNet defined the business processes between trading partners and created the transactions to support these processes. RosettaNet recognized that most business processes were not just transactions but were in fact finite state machines where the transactions between partners move each partner through state transitions. For example, a Purchase Order transaction was not just a message but placed the trading partners in specific states: the selling partner in a state to deliver the item and the buying partner in a state to receive the item. A transaction to change the terms of the Purchase Order changes the states of both partners. The business processes are closed loop in that both trading partners must acknowledge moving to complementary states and both must end in terminating states at the end of the process. They coined the term “Partner Interface Process”, or PIP, that defined the specific states for each trading partner and the message contents for each transaction that changed the state of the partners. RosettaNet attempted to define in a very complete structure the definition and implementation of real business processes. The business processes included the establishment of the trading relationship: partner identification, shipping address, payment terms, etc. This information is long term and is static for each transaction. The business process definition includes the closed loop transactions for the initial orders and subsequent changes and the potential exceptions that may occur at the trading partner interface. There was the expectation illustrated in FIG. 2, where trading partner A 1 with enterprise systems A 2 could execute the closed loop process with trading partner B 4 with enterprise systems B 5 using the RosettaNet Purchase Order PIP with an initial RosettaNet Purchase Order transaction 11 and the RosettaNet Change transaction 12 to complete the initial order and subsequent changes to the order. However, this has not come to past. RosettaNet defined the processes between trading partners and covered most of the exception situations as seen at the trading partner interface. However, RosettaNet did not (and could not) define how each enterprise should detect these exceptions nor define how to process these within the enterprise. The level of complexity within the enterprise due to exceptions is significantly more than seen at the trading partner interface. Also, most enterprise systems do not have the capabilities to manage all the exceptions and changes. Even with the most experienced people, they have found it very difficult to define all of the exceptions so that the integration could be programmed and be effective. The experience and insight of people are needed to detect and process the exceptions. This does not mean that these business processes will forever be a manual process but a means to permit the systems that support RosettaNet to evolve is needed. A expectation that a definition of business processes between diverse trading partners and the integration to their diverse enterprise systems as an initial implementation is not realistic. Business-to-business electronic commerce is a complex, distributed system. Every large system that works was once a small, simple system that worked. No large system that works was implemented as a large system but as a small working system that evolved and grew. One objective of the present invention is to provide the framework so that a public business-to-business information transfer standard protocol like RosettaNet can begin to function and evolve to fulfill its promised expectations.

The prior art provides RosettaNet clients that run on a PC or Web hosted server where the RosettaNet transaction is displayed as fields on the Web screen and a person could use the manual entry fields to respond to the transaction. This is similar to the PC programs for EDI that provided a user interface to the fields of an EDI transaction so that a trading partner could participate in an EDI network without connection to their enterprise systems. The prior art RosettaNet client is transaction focused and does not provide the functions needed to support the business processes.

### THE TOPOLOGY

In the late years of the 20^{th} century, there was the expectation that electronic market places called public exchanges would be the preferred topology for electronic commerce. The public exchange would provide many standards and enable enterprises to exchange business information much easier than the direct point-to-point connections of EDI or the Internet addressed connections of RosettaNet. However, public exchanges raised many issues centered on the advantages that the exchange owner would accrue because of the central locus of the exchange. All of the transactions would flow through the exchange and issues of information privacy; potential aggregation of information by the exchange owners; business process ownership; and many other similar problems faced the exchange participants and owners. In addition, to gain benefit, the trading partners had to integrate their systems to the exchange. The integration posed all of the unresolved issues of integrating to trading partners. While the exchange owners would argue that by integrating to their exchange, the single integration would permit connection to all other partners of the exchange. However, the argument fell apart when only a small number of companies, albeit large companies, committed to be part of each exchange and the number of exchanges that an enterprise had to integrate were growing. It was clear to many that the bulk of the benefits of the exchange would go to the owners and even stock ownership by some of the participants did not assure that the benefits would flow to them but to the management of the exchange. The public exchange is failing as a business model.

A new model, called the private exchange is rapidly evolving. Private exchanges serve two functions: 1) provide a single, consistent interface to customers and suppliers for a multi-site enterprise; 2) provide a view of consolidated enterprise information, usually transaction data. Customers and suppliers may be given access to the information to improve communications. FIG. 3 illustrates the 8 point-to-point interfaces 32 that Partner A Site A 30 would require to communicate with 8 trading partners such as Partner B 4. If Partner A had four sites, Partner A Site A 30, Partner A Site B 33, Partner A Site C 34, and Partner A Site D 35, the number of point-to-point interfaces 32 increases to 44 as illustrated in FIG. 4. Many enterprises have significantly more sites and significantly more trading partners. The number of interfaces can be very large. Also, the integration of each site might be different so the trading partners see different information from the sites. Since the transactions are distributed, Partner A could not easily see a consolidated view of all of the transactions. The private exchange helps solve both of these issues. FIG. 5 illustrates Partner A Private Exchange 40 and the reduced number of point-to-point interfaces 32 to 12. A new site or partner is added with one added interface.

However, the interface and information are based on the business process of the Partner A and not necessarily those of the trading partner. As illustrated in FIG. 6, Partner A 1 has created a private exchange 40 and is to connect its enterprise systems 2 using the interface 32. Partner B 4 is to connect its enterprise system 5 using the interface 32. However, the business processes used by the private exchange 40 are Partner A business processes 50. Partner B 4 has to adapt to Partner A business processes 50 for this portion of its business and also adapt their enterprise systems 5 to accommodate these business processes. Also, Partner B 4 sees only that portion of the information that pertains to Partner A 1 and must aggregate information from all of the other Partner B 4 trading partners to be effective in executing the Partner B 4 business processes. The exchange is of value to the hosting enterprise, Partner A 1, but has much lower function and value to the trading partners. The trading partners must create their own private exchanges and integrate to all of their partners to gain similar value. In an environment with emerging business-to-business protocol standards where none are well used, many enterprises are hesitant to proceed with integrated implementation. History has shown that it takes a long time, if ever, to get a standard established and provide economic returns. Also, implementation path is not clear. Business processes may have to change. The investments may be large and the returns not clear.

Aggressive enterprises that have power are creating private exchanges and demanding that their trading partners conform. Some do and some don't but many don't see the value of the private exchange unless it provides improvements to them. Each trading partner has different business processes. Some differences are because one is a buyer and the other seller. Some differences are because one partner believes that they have evolved a superior business process and that it gives them a competitive advantage. So partners are forced to use the private exchange of the strong partner. This forces them to use the business-to-business information transfer protocol selected by the strong partner and are also forced to use the business processes of the strong partner that are embedded in the private exchange. The attaching partners may have a large number of strong partners, usually their customers, and thus, have to accommodate this large number of different protocols and business processes. Most partners do not have their own private exchange nor have they integrated the set of protocols to their systems. Public exchanges were once thought to be a solution to this problem but these have all of the shortcomings of the private exchange except that all participants are attaching partners. Thus, no one was able to get any advantage for the investment in time and money. The public exchange business model has not proven to be successful. The private exchange provides value to the owner of the exchange so a strong trading partner will push to have their partners connect to their private exchange.

The private exchange model has significant advantages for the hosting enterprise but not for the attaching partners. An ideal topology is where each enterprise has its own private exchange and the point-to-point interfaces between private exchanges. A second objective of the present invention is to foster the establishment and evolution of networks of private exchanges.

Capability Delivery

The implementation of an industry standard information transfer protocol and private exchanges faces many challenges. Most enterprise systems are site centric and serve that function well. That is, the systems are designed to support limited set of variations of business processes for a site but cannot be extended to provide the functions of the exchange. The level of function required for an exchange is quite different from that of a site. The exchange must provide a global view and a site view. A new system model must be defined. Most enterprises do not have the Information Systems. IS, organizations that have the experience to define or even implement an exchange. Many enterprises have made significant investments in systems and have not seen the return on these investments. They are very hesitant to invest again unless there is a clear, quick, measurable return on the investment. The Application Service Provider, ASP, model seemed to address some of these issues by providing the enterprise system capabilities over the Internet or private networks. The ASP model removed the need for enterprise IS staffing and up front investment in hardware and software licenses. But the site centric requirements of the enterprise systems made the implementation of the ASP systems difficult. It had all of the issues of implementing enterprise systems that did not disappear just because the systems were hosted on the Web.

However, the private exchange has requirements quite different from the enterprise systems. A third objective of the present invention is to provide a means to deliver the industry standard protocol and private exchange to minimize the impact to the enterprise and attaching partners.

The objectives of the present invention is to provide:

1) An enterprise an effective means to evolve their business processes and the systems to support these processes as a small starter system rather than an “all or nothing” large system implementation.

2) An enterprise an effective means to implement a private exchange.

3) The trading partners of the exchange an incentive to attach to the private exchange where they gain significant advantages and thus want to attach

4) A strategy for a business-to-business information transfer protocol standard like RosettaNet to become established

5) A strategy and mechanism for a service provider model with a “viral” effect where trading partners of the service provider gain advantage and want the service.

### BRIEF DESCRIPTION OF DRAWINGS

FIG. 1 illustrates the transactions between trading partners using EDI, FAX, e-mail and phone.

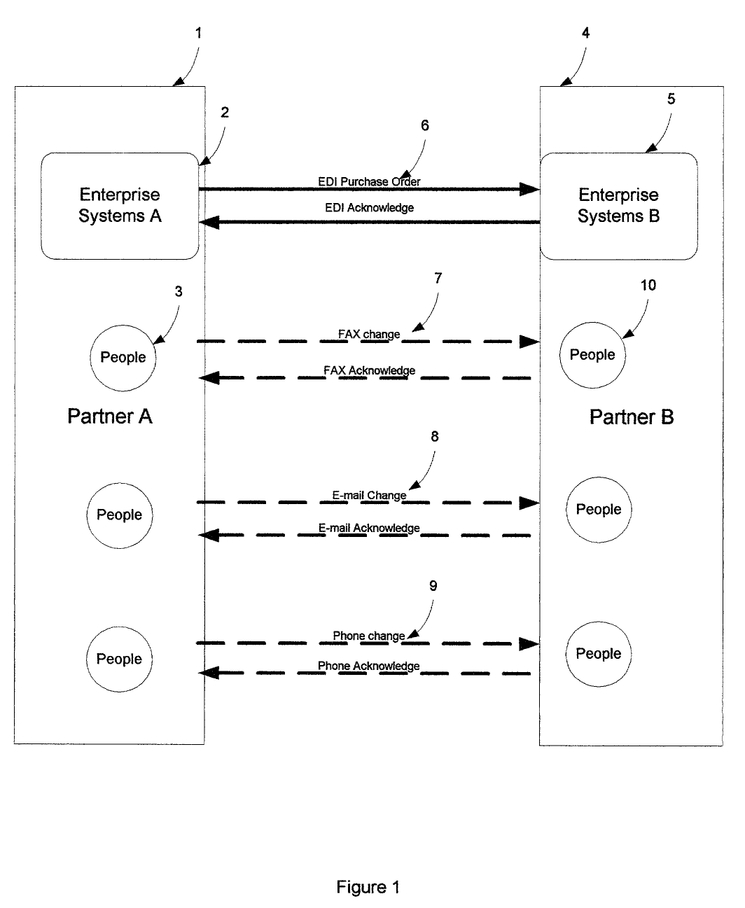

FIG. 2 illustrates the transactions between trading partners using RosettaNet protocol.

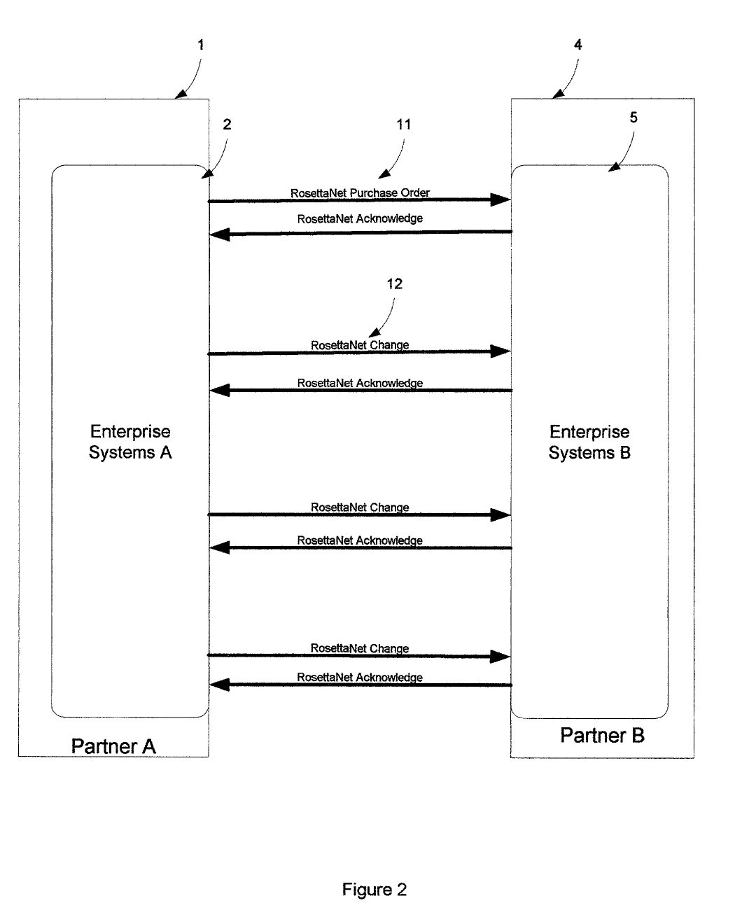

FIG. 3 illustrates the topology to interconnect a site with a set of trading partners.

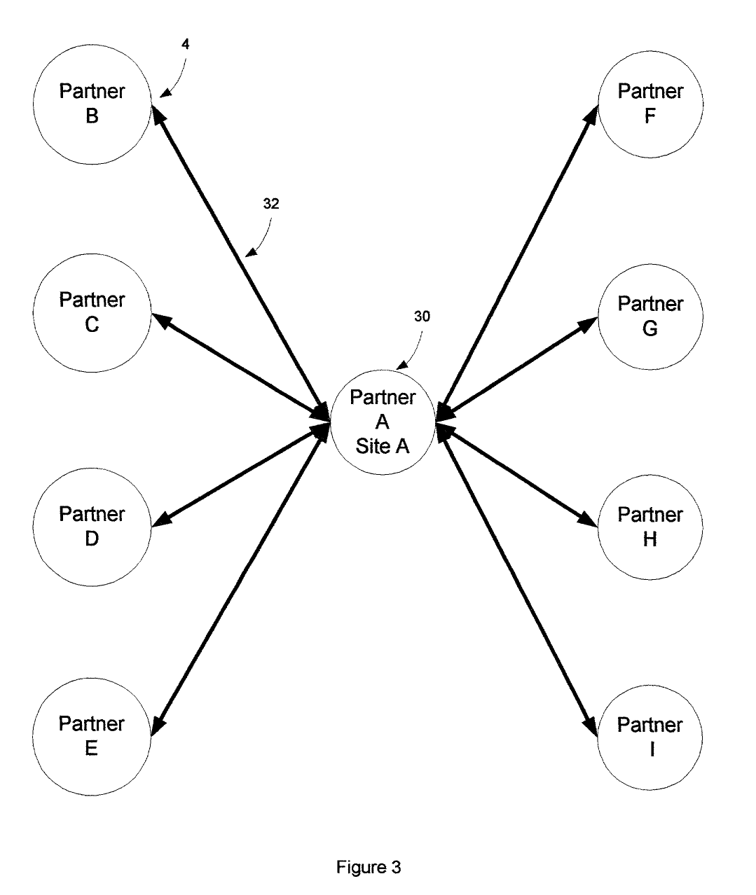

FIG. 4 illustrates the topology to interconnect four sites with the set of trading partners.

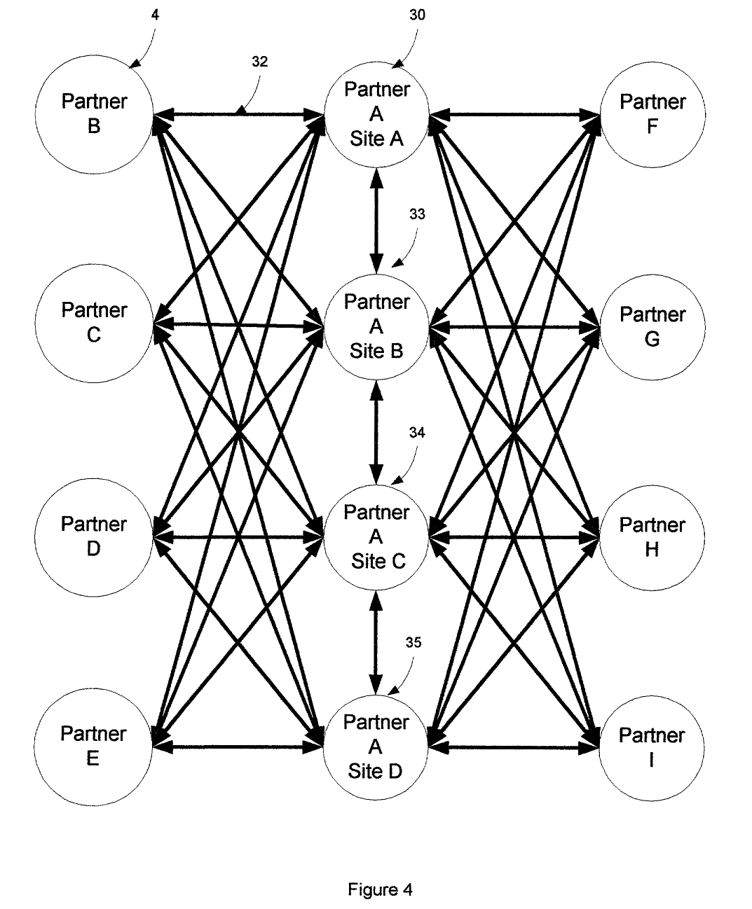

FIG. 5 illustrates the topology with a private exchange to interconnect the fours sites and the set of trading partners.

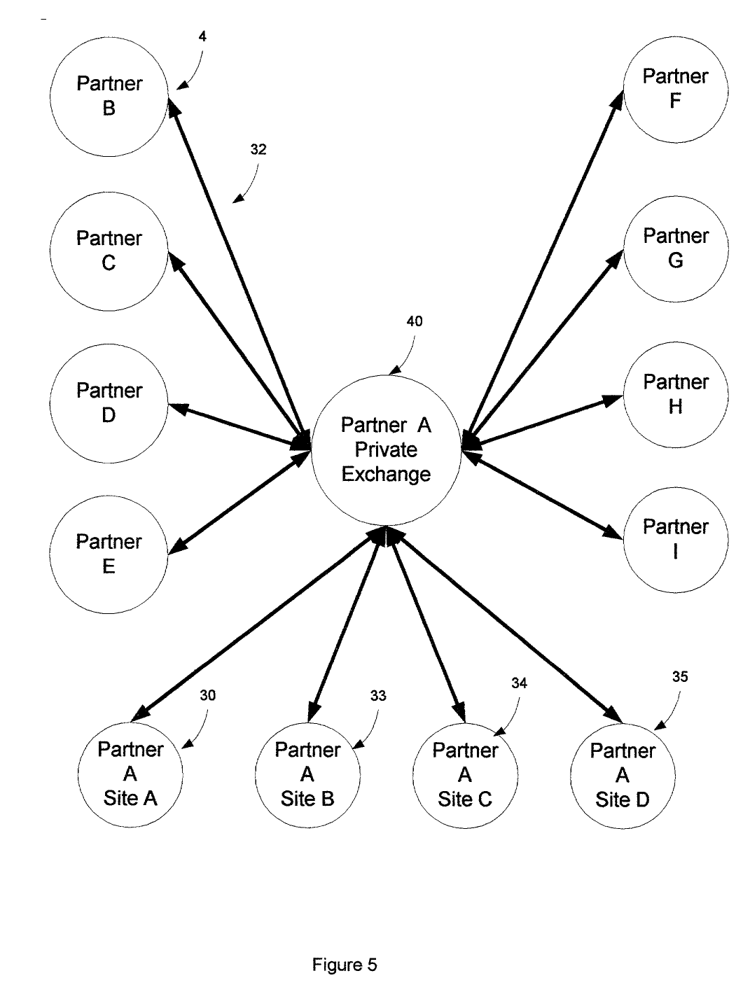

FIG. 6 illustrates two trading partners in a private exchange with one business process.

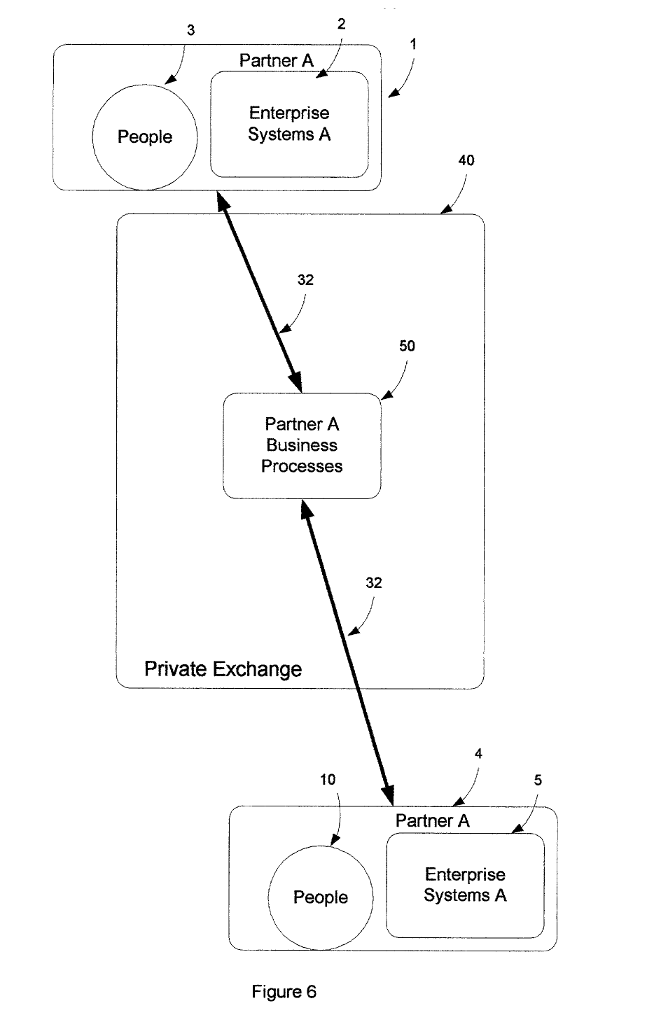

FIG. 7 illustrates the RosettaNet system and interfaces to trading partner and to user.

FIG. 8 illustrates the RosettaNet system filter function and integration to enterprise systems.

FIG. 9 illustrates a private exchange with a RosettaNet system for each trading partner.

FIG. 10 illustrates a private exchange adding a third trading partner and RosettaNet system.

FIG. 11 illustrates a private exchange with an external trading partner with RosettaNet system.

FIG. 12 illustrates a RosettaNet system to consolidate transactions from two other RosettaNet systems.

FIG. 13 illustrates the server structure for a preferred embodiment of a RosettaNet system.

FIG. 14 illustrates a flow chart of the steps to complete the processing of a transaction in a RosettaNet system.

### DESCRIPTION OF THE INVENTION

The first function of the present invention provides a complete RosettaNet system as a hosted Web service. All of the information and entry of responses needed to execute the RosettaNet PIP's with a trading partner is provided using a Internet Web browser. The RosettaNet system maintains the state and information of each active PIP instance and the history of completed PIP instances. The functions are significantly more than the prior art RosettaNet transaction display systems. The Web interface provides a means to selectively extract information from the hosted RosettaNet system for entry into the enterprise systems of the trading partner. This provides a means to selectively integrate information into the enterprise systems for more automated processing and generation of responses to the trading partners. The Web interface provides means to selectively insert information into the RosettaNet system. This provides a means to selectively integrate information from the enterprise systems into the RosettaNet system to more automate the responses and new PIP instance creation to the trading partners. The selection functions can be more automated so that each PIP transaction is filtered for either manual processing using the Web interface or automated forwarding to the enterprise systems. These levels of function will permit trading partners to use RosettaNet to understand the value it delivers and how to begin to process the exceptions that take the insight of a person to resolve

The second function of the present invention is to provide a private exchange where each trading partner has a dedicated RosettaNet system and these RosettaNet systems communicate with each other using the RosettaNet PIP protocol. Each trading partner may have independent business processes and integrate with their own enterprise systems using the Web interface described earlier. Since RosettaNet is defined as an Internet based protocol, the business-to-business interface may be externalized and used to communicate with trading partners outside the private exchange. This permits each trading partner use of their RosettaNet system with all of their RosettaNet based trading partners and not just those in the private exchange. In fact this will permit trading partners to leave the private exchange to create their own private exchange or another private exchange. The RosettaNet system provides a means for a multi-site enterprise to consolidate the external interface to their trading partners without impacting their sites and their different enterprise systems.

The third function of the present invention is to provide the capabilities as a hosted service where each participant needs only an Internet Web browser and the interface provide a means for each partner to easily accommodate their business process and enterprise systems at their end of the interface. This permits the service provider to have a standard system and not tailor the system for each partner. The hosted service as part of a private exchange permits partners to use the private exchange as an “incubator” for their RosettaNet implementation and permits each to evolve their integration to their enterprise systems. Each partner gains value from the private exchange and can connect to their trading partners external to the exchange. The barrier to use of RosettaNet is just an Internet connection and a PC with a Web browser. Most homes have these capabilities so it is difficult for a trading partner to assert lack of system capability to prevent participation in a RosettaNet trading network. The RosettaNet system hosting service provider has a viral effect where partners spread the requirement to join to their partners.

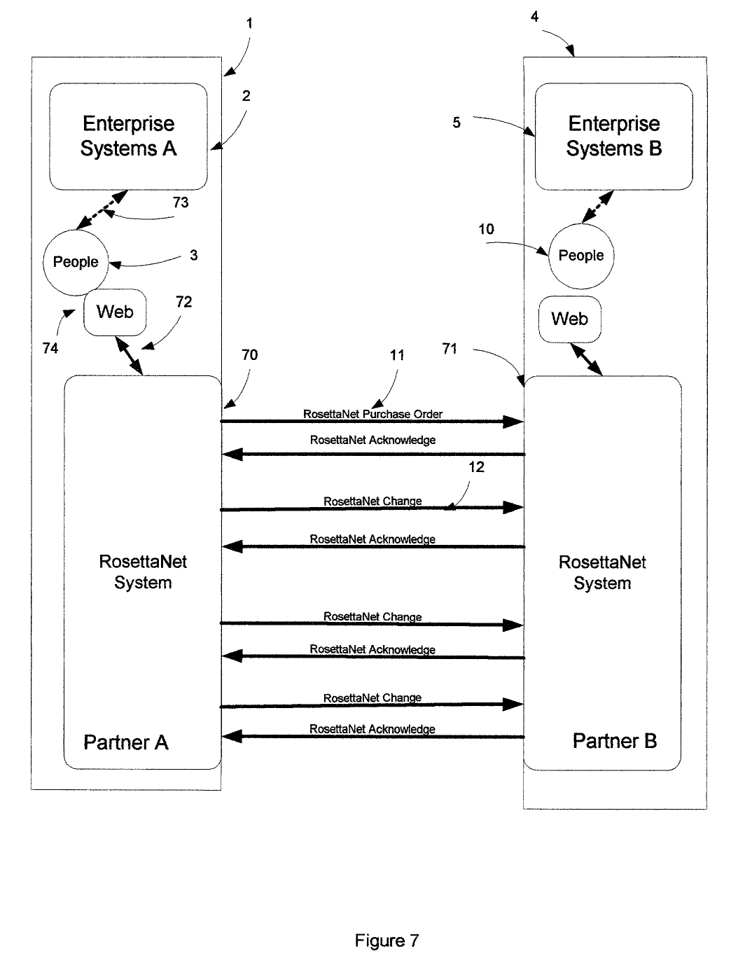

FIG. 7 illustrates Partner A 1 with its RosettaNet system 70. The people 3 of Partner A 1 access their RosettaNet system 70 using the Internet connection 72 and Web browser interface 74. The RosettaNet system 70 provides all of the finite state behavior and information required by the RosettaNet PIP's so that the business processes can be executed. For Purchase Order processing, reports that show all open orders, late orders, orders from specific trading partners, order changes, etc. are provided so that the people 3 can process the purchase orders at the partner interface. The internal purchase order processing is still done on Partner A enterprise systems 2 and initially the transfer of information 73 between the RosettaNet system 70 and the Partner A enterprise systems 2 is accomplished by people 3 using the screens of both systems and manually transferring the information. Recall that a large fraction of the purchase order transactions are to change the purchase order. Most of these are done manually using phone, FAX, and e-mail with little or no systems to assist the people 3. The RosettaNet system 70 even though used manually provides significant commercial value. Partner B 4 has RosettaNet system 71 with similar Internet connection and Web interface so that their people 10 can manually integrate the information with Partner B enterprise systems 5. Both partners gain the benefit of RosettaNet and system assistance for closed loop business processes such as Purchase Order management including the changes.

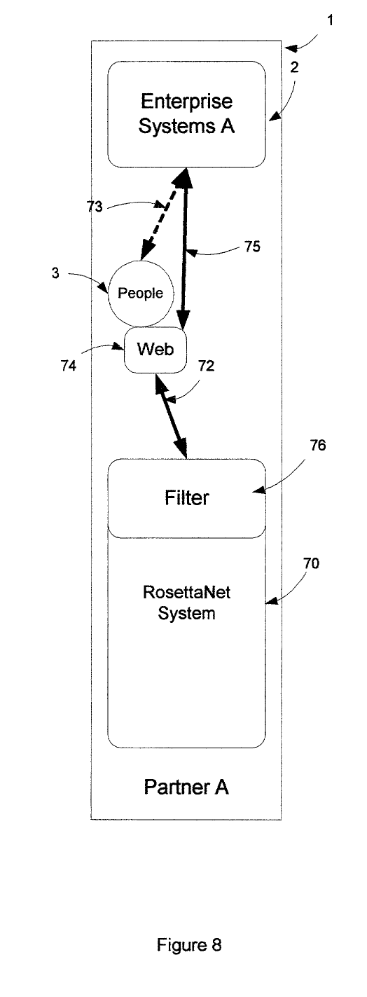

FIG. 8 illustrate Partner A 1 with its RosettaNet system 70 where information can be selected for transfer 75 to the enterprise systems 2 and back to the RosettaNet system 70. This will permit the people 3 have a semi-automated integration between the two systems so the routine transactions may be processed with little human intervention. The Web interface would still be used for the exception processes that are not handled using the semi-automated integration. The filter function 76 of the RosettaNet system 70 permits the people 3 to set rules and values that compare the state and content of each PIP instance transaction and filter the transactions into three classes:

1) An automated response from the RosettaNet system 70. An example would be for a purchase order change that is within specific limits that would be approved and does not need to notify the enterprise systems 2;

2) A transaction that has a defined process and system integration and passed directly to the enterprise systems 2 as an enterprise systems message. An example would be for the initial purchase order that can be passed directly to the enterprise systems 2;

3) A transaction that does not have system integration and needs to be processed by people 3. An example would be for a purchase order change for an item with limited supply, situations where people 3 are best at resolving.

The filter function 76 permits each partner to tailor the integration to each of their enterprise systems in an evolutionary way so that they can gain understanding of the transactions and exception situations using the experience of their people for processing the exception conditions. It is envisioned that even when most of the transactions are processes using systems, there will still be exception transactions that need the insight of people. The prior art RosettaNet integration strategy expects all of the transactions to be processed by systems and does not account for exceptions that will require manual processing. This has made automating RosettaNet difficult and has been a barrier for wide adoption. The filter function 76 starts with the assumption that all transactions are to be processes manually and the integration to systems evolves as the transactions become better understood and automated. This permits each partner to begin use of RosettaNet immediately using manual processes. In most implementations the transaction volumes are low during the initial periods so manual processing may be acceptable. The partner gains experience and automates the processes and transactions that make business sense at the pace driven by business requirements. The manual processing assures that all transactions are processed.

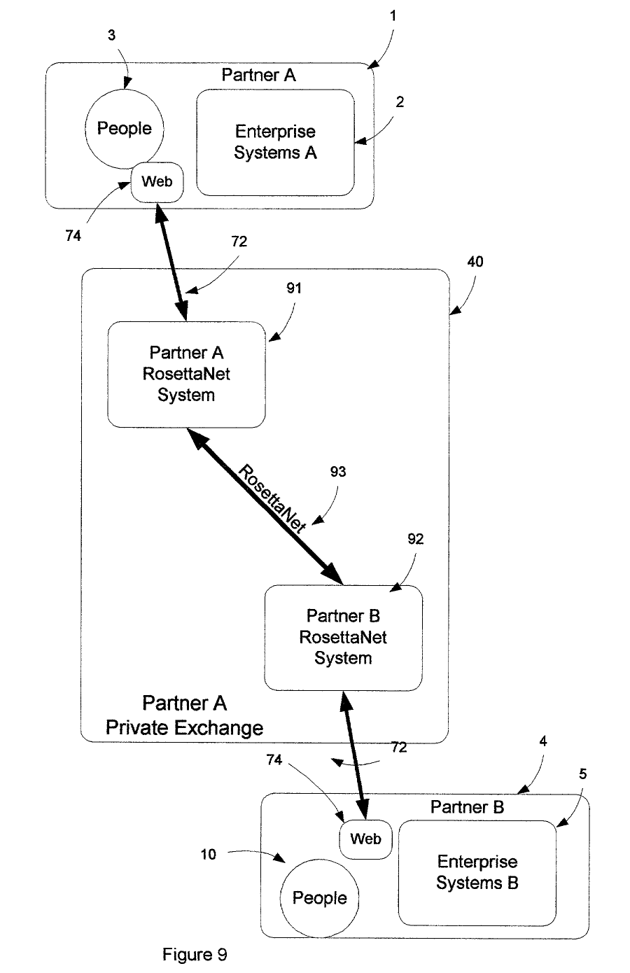

FIG. 9 illustrates a Partner A private exchange 40 where Partner A 1 has a RosettaNet system 91 and Partner B 4 has RosettaNet system 92. The two RosettaNet systems 91, 92 are connected using RosettaNet protocols 93. Each partner access their RosettaNet system 91, 92 using the Internet connections 72 and web browser 74 for people 3, 10 and enterprise systems 2, 5 as described in the earlier paragraphs. Note that while Partner B 4 is participating in the Partner A private exchange 40, it has its own independent RosettaNet system 92 and can evolve its business processes and integration to enterprise systems 5 independent of Partner A 1. Partner B 4 gains value from the Partner A private exchange 40 beyond the ability to trade with Partner A 1.

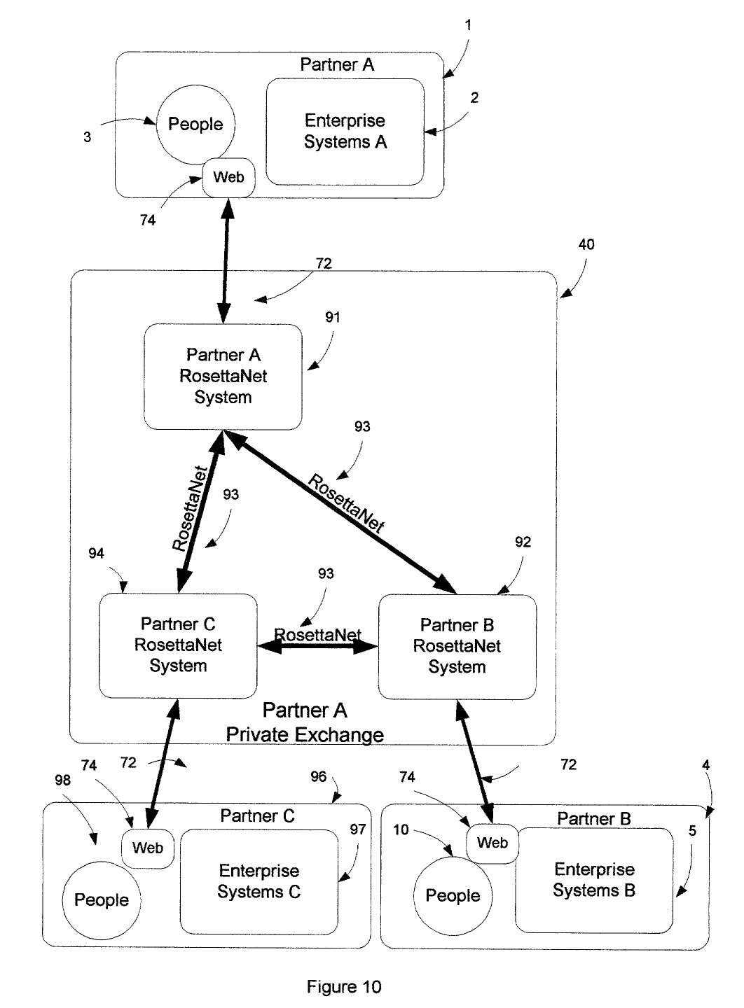

FIG. 10 illustrates the Partner A private exchange 40 where a third partner, Partner C 96 is a participant. Partner C 96 has a RosettaNet system 94 in the Partner A private exchange 40. The three RosettaNet systems 91, 92, 94 are connected using RosettaNet protocols 93. Partner C 96 can conduct RosettaNet transactions with Partner A 1 and also with Partner B 4. All participants in the Partner A private exchange 40 are equals and peers.

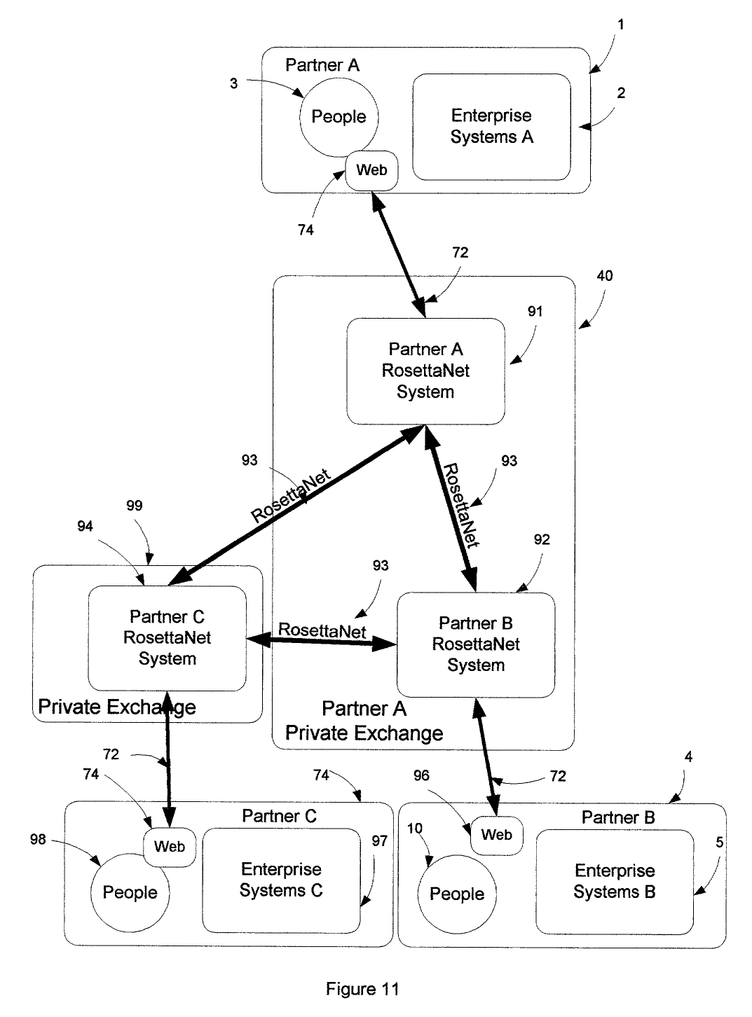

FIG. 11 illustrates how the RosettaNet protocols 93 permit communications with external RosettaNet systems. The Partner C RosettaNet 94 system is external to the Partner A private exchange 40 and can communicate with Partner A RosettaNet system 91 and with Partner B RosettaNet system 92 in the same manner as communications within the Partner A private exchange 40. The external connections permit Partner B 4 to transact with other trading partners that are outside of the Partner A private exchange 40.

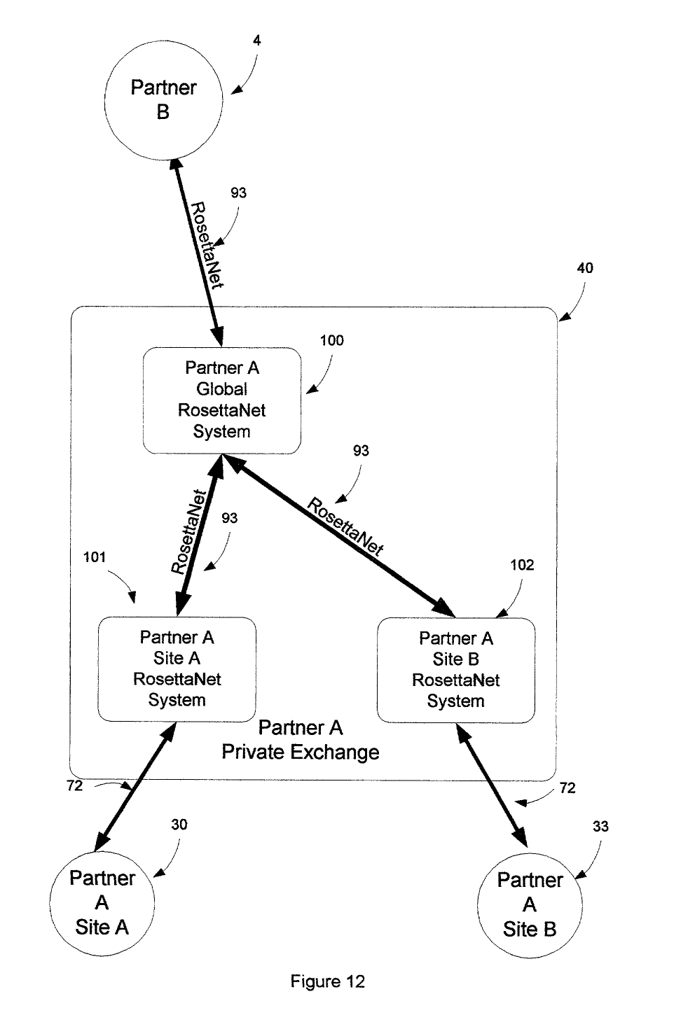

FIG. 12 illustrates how Partner A 1 can use RosettaNet systems and RosettaNet protocols to consolidate all of the transactions from each of its sites so that Partner A 1 can have a consistent interface to all of its trading partners and also have a consolidated view of all transactions. The Partner A private exchange 40 connects Partner A Site A 30 to its Partner A Site A RosettaNet system 101 using the Internet 73, Partner A Site B 33 to its Partner A Site B RosettaNet system 102 using the Internet 73. Site RosettaNet systems 101, 102 are connected to a Partner A Global RosettaNet system 100 using RosettaNet protocols 93. The Partner A Global RosettaNet system 100 has an external connection to the RosettaNet interface of Partner B 4 using RosettaNet protocols 93. All transactions between a site of Partner A and a trading partner flow through the Partner A Global RosettaNet system 100. This serves to provide a consistent interface to the Partner A trading partners and provides a consolidated view of all transactions for Partner A. The individual RosettaNet systems for each site decouple the business processes among the sites so that they may support the local site requirements while still integrating at a global level.

The present invention suggests a strategy for gaining the benefits of a business-to-business protocol like RosettaNet. Implementation begins with a few strong partners creating private exchanges and hosting their trading partner with independent RosettaNet systems. Each partner gains the benefit of the exchange, RosettaNet system, and gains experience to integrate the RosettaNet transactions to their systems. Some of the trading partners begin use their independent RosettaNet systems to communicate with other trading partners within the private exchange. Then, some of the partners begin communications with partners hosted in other exchanges using the external RosettaNet and the Internet. Then, some of the partners move their RosettaNet systems to their own private exchanges. Some multi-site partners with multiple enterprise systems will create global RosettaNet systems to provide internal integration and external consistency. The RosettaNet systems are standard and may be hosted remote from the trading partners. This suggests that a service provider model may be successful and avoid the issues of the enterprise systems Application Service Provider model.

Description of a Preferred Embodiment

Rosettanet System

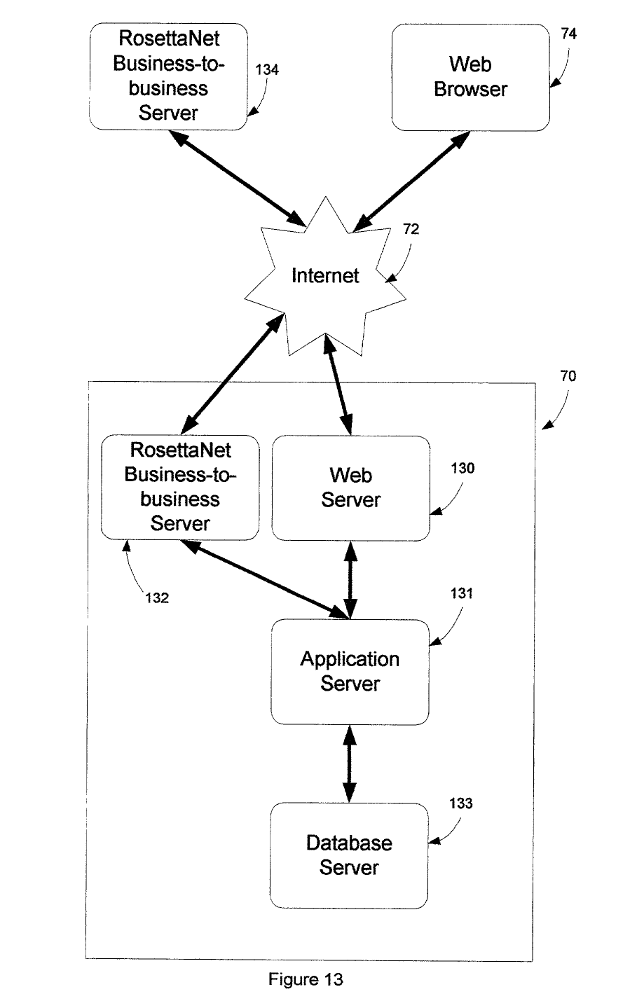

A RosettaNet system 70, illustrated in FIG. 13, consists of an Application Server 131, a Web Server 130, a Data Base Server 133, and a RosettaNet Business-to-business Server 132. These servers are software programs that execute on server hardware such as a PC from Dell or Compaq, a workstation or network server from SUN or Hewlett Packard, or a mainframe computer from IBM. The server hardware can have operating system services using for example, Microsoft Windows NT, Windows 2000, Sun Solaris, Hewlett Packard HP/UX, IBM O/S 9000, Lenix, etc. The Application Server program may be written in Java, C++, Visual Basic, or a variety of programming languages. Or, the program may be written to execute in an applet or Java bean server such as provided by BEA Software or IBM Web Sphere or others. Microsoft Internet Integration Server, Netscape Web Server, or a variety of web server programs may provide the Web server program. Oracle 9i Data Base, IBM DB2, Microsoft SQLServer, or other databases may provide the data base program. Extricity, Netfish, Vitria, are among a set of software providers of RosettaNet business-to-business server programs. The Web server and the RosettaNet Business-to-business server connect to the Internet 72. Using the Internet, the Web Server connects to one or more Web clients 74 executing a Web browser, for example, Microsoft Internet Explorer or Netscape Navigator. The Web clients may be workstations, PC's, mainframe terminals, etc. However, a number of web clients are wireless devices such as: PDA's, cell phones, two way pagers, etc. The program in the Application Server 131 provides the RosettaNet system functions and uses the Web Server 130 to connect to the Web clients 74, the RosettaNet Business-to-business Server 132 to connect to another RosettaNet Business-to-business Server 134, and the Database Server 133 to store all of the business and process information.

Transaction standards like RosettaNet require two types of information:

1. Information that describes and defines a trading partner, environmental information. This is initialized when an association with a trading partner is established and only changes when the trading partner changes a parameter such as shipping address as an example. RosettaNet has defined a set of transactions for trading partners to exchange this type of information on an as needed basis. This is static information that is imbedded in each business process transaction to identify the partners.

2. Information that describes and defines a business process transaction such as a purchase order. This is initialized at the beginning of a transaction by the initiating partner and may change as the transaction goes through a closed loop process. This is dynamic data that is used by the enterprise to run its business and may change the data in the response to its trading partner to reflect the business response.

In addition, each active PIP instance is in a state of the finite state machine describing the behavior of the PIP. The finite state machine for each PIP can be described as a table of rows and columns where each state has a row and each transaction has a column. Each row has an entry in the transaction columns indicating the state to which the state machine should move should that transaction be received and entries indicating the possible output transactions, if any. There are many ways known in the art to represent finite state machines and their behavior. The environmental information and the dynamic process information and state for each active PIP instance are kept in the Database Server 133. The dynamic process information for completed PIP's are also kept in the Database Server 133. The Application Server program can present in a Web screen of a Web client 74 all active the active PIP's that are awaiting a response. The processing of the active PIP instances is an ideal application for a workflow system to distribute the work steps and to measure and assure the execution of the PIP. When a user at the Web client 74 selects an active PIP instance, the Web Server 130 passes the response to the Application Server 131, which then extracts the dynamic and static field information from the Database Server 133. The Application Server 131 creates Web screen to display these fields and the response fields and sends the screen to the Web Server 130 to send to the Web client 74 to display to the user. The user decides the response and fills in the response fields and submits the information through the Web client 74 to the Web Server 130 to the Application Server 131. The Application Server stores the response and the new state in the Database Server 133 and also creates a RosettaNet transaction that is sent to the RosettaNet Business-to-business Server 132. The RosettaNet Business-to-business Server 132 sends the RosettaNet transaction through the Internet 72 to the corresponding RosettaNet Business-to-business Server 134. The RosettaNet Business-to-business Server 134 sends back the response indicating that the transaction was received to the RosettaNet Business-to-business Server 132 which then sends it to the Application Server 131 which then updates the state field for this PIP instance in the Database Server 133 to indicate that the transaction was received by the trading partner. Those skilled in the are recognize the Web Server 130, Application Server 131, and Database Server 133 structure as one that is used for many Web applications. As such, database queries can provide, for example, reports on active PIP instances, open Purchase Orders; late deliveries, promise date field less than or equal to the current date; etc. A new PIP instance is created by merging the static information that describes the sending trading partner and the receiving trading partner then presents the fields that need to be filled by the user.

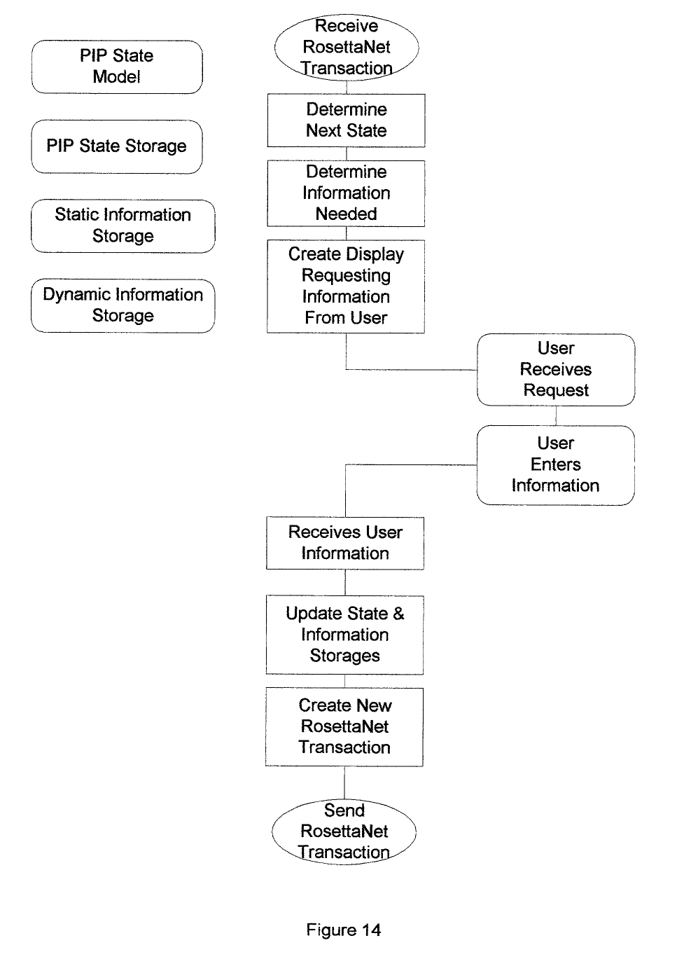

A simplified RosettaNet system process flow is illustrated in FIG. 14. The RosettaNet system has a PIP State Model, PIP State Storage, Static Information Storage, and Dynamic Information Storage. The RosettaNet system receives a RosettaNet transaction. The next PIP State is determined from the transaction information, the current PIP state in the PIP State Storage, and the PIP State Model. The Information needed is determined from next PIP state, the transaction information, and the Dynamic information in the Dynamic Information Storage. The RosettaNet system generates a screen to request the information from the user and sends the screen to the display. The user determines the requested information, enters it into the display, and sends it back to the RosettaNet system. The RosettaNet system receives the requested information, updates the PIP State Storage to reflect the next PIP state, updates the Dynamic Information Storage with the new information, creates a new RosettaNet transaction using the information from the user and the Dynamic and Static Information Storage, and sends the new RosettaNet transaction.

Specific information in fields may be selected from the Database Service 133 by the Application Server 131 in response to a Web client 74 request and sent to the Web client 74 (of course through the Application Server 131 and Web Server 130). This provides a mechanism to transfer information from the RosettaNet system to the enterprise systems. In a similar manner information from the Web client 74 can request the Application Server 131 that information be sent to the Database Server 133 for updating fields or inserting new information into fields. This provides a mechanism to transfer information from the enterprise systems to the RosettaNet system.

The filter function 76 of the RosettaNet system 70 permits the people 3 to set rules and values that compare the state and content of each PIP instance transaction and filter the transactions into classes. The rules and field values are stored in the Database Server 133. When a transaction is received by the RosettaNet Business-to-business Server 132 and passed to the Application Server 131, the Application Server 131 access the rules and field values from the Database Server 133 and compares the fields in the transaction and applies the rules to determine the classification of the transaction. If the transaction is determined to have an automated response, the Application Server 131 creates the response and sends it to the RosettaNet Business-to-business Server 132 to be sent to the appropriate partner RosettaNet Business-to-business Server 134; sends an update to the state and other field information to the Database Server 132. If the transaction is determined to be sent to the enterprise server, the Application Server 131 prepares the field information to send to the Web client 74 for transmission to the enterprise system; sends the field to the Web Server 130 then sent to the Web client 74; and updates the Database Server 132 with the field data and the PIP instance state. If the transaction is determined to be processed using the Web client 74, the field information, state, and other information are stored in the Database Server 132 for Web client 74 processing.

Private Exchange Server

The Private Exchange Server 40, FIG. 9, consists of the same set of servers as the RosettaNet system: an Application Server 131, a Web Server 130, a Database Server 133, and a RosettaNet Business-to-business Server 132. The fields in the Database Server 133 are divided to separate the information for each RosettaNet system 91, 92 so business processes and business information for each partner are distinct and separate. The communications between RosettaNet system 91 to RosettaNet system 92 is accomplished by the Application Server 131 sending a transaction (from RosettaNet system 91 to RosettaNet system 92) to the RosettaNet Business-to-business Server 132. The RosettaNet Business-to-business Server 132 identifies RosettaNet system 92 as one belonging to Private Exchange Server 40 and sends the transaction to Application Server 131, which then processes the transaction on behalf of RosettaNet system 92. Note that if the receiving RosettaNet system were outside of Private Exchange Server 40, the RosettaNet Business-to-business Server 132 would send the transaction to the Internet address of the external RosettaNet system. The number of RosettaNet systems that can be supported by a Private Exchange as described would not be limited by architectural limits but by the capacities of the servers. Server cluster technology can extend the limit to any commercially feasible number. The Private Exchange 70 is designed to host RosettaNet systems as a Web based Internet service and can be positioned anywhere accessible by the Internet. Unlike the ASP model, the RosettaNet system capabilities are established as a standard and as such immune to the need to customize to fit a particular trading partner's requirements. In fact, the partner's enterprise systems are the element to accommodate these requirements. Thus, the Private Exchange 70 is ideal for a service delivery model.

The description of the RosettaNet system 70 and Private Exchange Server 40 were described in terms of RosettaNet as an example of a business-to-business information transfer protocol. The RosettaNet system is not limited to supporting RosettaNet but to the general class of information transfer protocols where the sending element and receiving elements can be described as finite state machines and the transactions between the sending element and receiving element not only sends information but also changes the states of these elements; the information sent contains fields that contain relatively static information, trading partner identification as an example, and dynamic information, purchase order delivery date as an example; and the collection of dynamic information when selected can be useful for users processing the transactions so that the entire closed loop business process with the trading partner can be accomplished within the RosettaNet system. However, it is recognized that a significant portion of the business process is concerned with the internal determination of the transaction. The internal enterprise systems are usually best suited to make this determination. The RosettaNet system supports the selective extraction of information as a means to import information into the enterprise systems and the selective updating and insertion of information as a means to import information into the RosettaNet system from the enterprise systems. The RosettaNet system also provides a rules and field comparison means to determine if a transaction is classified for an automated response, a transfer of information to the enterprise systems, or to be processed manually. The Private Exchange Server is not limited to support RosettaNet or RosettaNet systems but the general class of information exchange servers where trading partners share business information using controlled business processes. The Private Exchange Server separates the business information and business processes so that each trading partner has its own separate business information and business processes. Information between the trading partners is transferred using an information transfer protocol like RosettaNet. The use of the Private Exchange is not limited to trading partners but can be applied to the sites of a multi-site enterprise where each site has its own business information and business processes and the enterprise has a global business information and business processes to provide a consistent interface to trading partners and consolidate the transactions with trading partners.

The present invention is not limited to the information transfer protocol as described using the Internet and Web browsers but can be applied to local area networks, wide area networks, wireless networks, or other communications means. The RosettaNet system and Private Exchange Servers may be physically located anywhere that can be connected to the Internet or other network and the functions useable as a signal propagated on the Internet or other network when connected to a suitable client program such as a Web browser program. Use of the propagated signal is in effect use of the present invention.

I claim:

1. An information transfer protocol system connected to a network, a computer with a display for a user connected to the network, and an information transfer protocol using the network and supporting a process describable as a finite state machine and a state dependent information transfer message
where the information transfer protocol system comprising
the finite state machine describing the process,
an information storage,
a process state storage;
receives a first state dependent information transfer message from the network; determines from the process state storage, the first state dependent information transfer message, and the finite state machine describing the process, the next state of the process;
determines from the next state of the process, the first state dependent information transfer message, and the information storage, the information needed to be entered by the user;
generates a screen displaying information from the first state dependent information transfer message and the information storage and requesting the information needed to be entered by the user;
sends the screen to the computer with the display for the user to enter the requested information;
receives the requested information entered by the user;
updates the information storage;
updates the process state;
creates using the information entered by the user and information from the information storage, a second state dependent information transfer message;
sends the second state dependent information transfer message to the network;
and, completes the operation on the first state dependent information transfer message.

2. The information transfer protocol system of claim 1, wherein the network is the Internet and the computer with a display uses a Web browser for the display program.

3. The information transfer protocol system of claim 1, wherein the contents of the information storage or process state storage may be accessed from the network.

4. The information transfer protocol system of claim 1, wherein the contents of the information storage or process state storage may be altered from the network.

5. The information transfer protocol system of claim 1, further comprising a rule storage and a field value storage and before determining the information needed to be entered by the user, determines from the next state of the process, the first state dependent business information transfer message, the rule storage, and the field value storage, if an automated response is to be sent and if so determined,
updates the information storage;
updates the process state;
creates using the information from the information storage, the first state dependent transfer message, and the rule storage, a second state dependent information transfer message
sends the second state dependent information transfer message to the network
and, completes the operation on the first state dependent information transfer message.

6. The information transfer protocol system of claim 1, further comprising a rule storage and a field value storage and before determining the information needed to be entered by the user, determines from the next state of the process, the first state dependent business information transfer message, the rule storage, and the field value storage, if a enterprise systems message is to be sent and if so determined,
updates the information storage;
updates the process state;
creates using the information from the information storage, the first state dependent transfer message, and the rule storage, an enterprise systems message
sends the enterprise systems message to the network
and, completes the operation on the first state dependent information transfer message.

7. A private exchange server comprised of a first information transfer protocol system with a first user, a second information transfer protocol system with a second user, and an information transfer protocol wherein the first user modifies information in the first information transfer protocol system and based on the modification, the information transfer protocol modifies information in the second information transfer protocol system for use by the second user.

8. The private exchange server of claim 7 which is further comprised of a third information transfer protocol system with a third user wherein the first user modifies information in the first information transfer protocol system and based on this modification the information transfer protocol modifies information in the third information transfer protocol system for use by the third user.

9. The private exchange server of claim 7 and a fourth information transfer protocol system with a fourth user where the fourth information transfer protocol system is external to the private exchange server, both connected to a network that supports the information transfer protocol, wherein the first user modifies information in the first information transfer protocol system and based on this modification the information transfer protocol modifies information in the fourth information transfer protocol system for use by the fourth user.

10. The private exchange server of claim 7 which is further comprised of a fifth information transfer protocol system and a sixth information transfer protocol system with a sixth user where the sixth information transfer protocol system is external to the private exchange system, all connected to a network that supports the information transfer protocol, wherein the first user modifies information in the first information transfer protocol system and based on this modification the information transfer protocol modifies information in the fifth information transfer protocol system and based on this modification the information transfer protocol modifies information in the sixth information transfer protocol system for use by the sixth user.

11. The private exchange server of claim 7 and an external receiver of the information transfer protocol, both connected to a network that supports the information transfer protocol, wherein the first user modifies information in the first information transfer protocol system and based on this modification the information transfer protocol modifies information in the external receiver of the information transfer protocol.
